(19) United States
(12) Patent Application Publication
(10) Pub. No.: US 2012/0263908 A1
(43) Pub. Date: Oct. 18, 2012

(54) METHOD FOR APPLYING LEATHER TO VEHICLE INTERIOR PARTS

(75) Inventor: Elisabeth Krause-Güntner, Weiz (AT)

(73) Assignee: WOLLSDORF LEDER SCHMIDT & CO GES.M.B.H., Wollsdorf (AT)

(21) Appl. No.: 13/509,598

(22) PCT Filed: Nov. 10, 2010
(86) PCT No.: PCT/EP10/67193

§ 371 Date: Jun. 28, 2012

(30) Foreign Application Priority Data
Nov. 11, 2009 (EP) A 1785/2009

(51) Int. Cl. B29C 65/72; B32B 3/02; B32B 7/12; B29C 65/52; B32B 38/04

(52) U.S. Cl. 428/64.1; 156/60; 156/256; 156/93; 428/473

(57) ABSTRACT

In a method of manufacturing leather for being applied to components, the following procedural steps are performed: providing manufactured leather, and applying an adhesive layer to the rear side of the leather or, respectively, to a composite material face in case of a leather composite material, wherein a bonding adhesive is used for building up the adhesive layer, allowing repositioning of the leather or of the leather composite material essentially an arbitrary number of times.

### CROSS-REFERENCE TO RELATED APPLICATIONS

This application is a 371 of International Application No. PCT/EP2010/067193, filed 10 Nov. 2010, which claims priority to European Patent Application No. A 1785/2009, filed 11 Nov. 2009, which applications are hereby incorporated herein by reference in their entireties and from which applications priority is hereby claimed under 35 U.S.C. §119(e) and §120.

### FIELD

The invention relates to a method of manufacturing leather for being applied to components and the invention relates further to components having a leather surface produced by applying leather.

### BACKGROUND

Document AT 504 882 A4 discloses a method of manufacturing leather steering wheels for motor vehicles, wherein the leather steering wheel is coated with leather in sections. The leather is cut to size, sewn up into a strip ring or leather cladding, respectively, and subsequently coated with an adhesive. As an adhesive, a dry adhesive is used which is activated by heat in a pressing operation.

It has turned out to be a disadvantage of this known method of manufacturing a leather steering wheel and of this known leather steering wheel that the dry adhesive receives its adhesive properties only upon application of heat. Applying leather to steering wheels is, for the most part, a manual activity wherein the leather cladding has to be positioned in the correct place before it can be sewn up. It is thus the object of the adhesive to keep the leather cladding in a correct position for being sewn up and to prevent the leather from slipping on the leather steering wheel during the entire period of use of the leather steering wheel. In this known method, the dry adhesive cannot be used for prepositioning since it is activated by heat only during the pressing operation and then sticks immediately.

It has furthermore turned out to be a disadvantage of the known method that, after the activation of the adhesive by heat, the leather cladding can no longer be removed from the leather steering wheel without destroying the leather. Hence, it may happen, on the one hand, that the leather cladding slips during the pressing operation and the leather cladding is stuck together in an incorrect position. On the other hand, customer complaints and leather steering wheels which are sent back will, again and again, occur. In both cases, it is impossible to remove the leather cladding from the leather steering wheel in a nondestructive way, which is the reason for comparatively high additional costs.

Document WO 2009/016007 A1 discloses that, for applying leather to a steering wheel, a double-sided adhesive tape is to be stuck on the steering wheel or on a layer of foamed material which has already been applied to the steering wheel. Thereby it is possible to preposition the leather cladding on the steering wheel before the leather gets stuck in grooves and/or before sewing.

It has turned out to be a disadvantage of this known method of applying leather to steering wheels that the double-sided adhesive tape leads to the occurrence of the so-called grain pipeyness effect and thus to the formation of creases in the surface of the leather. This effect occurs if leather is stuck or, respectively, laminated to other materials before being processed further. Car manufacturers have test instructions for assessing objectively the grade of the formation of creases in the leather. By applying the double-sided adhesive tape, noticeable creases are impressed into the leather, which is why the double-sided adhesive tape leads to more waste during the application of leather to steering wheels. A further result of sticking the double-sided adhesive tape on the leather is a deterioration in leather properties such as flexibility and smoothness, which is also detrimental.

Finally, it has become apparent for the method of applying leather to steering wheels using a double-sided adhesive tape that the double-sided adhesive tape will lose its adhesive properties at temperatures above 50° C. In the motor industry, however, the specifications for steering wheels define a substantially larger field of application ranging, e.g., from −40° C. to +120° C., which is why customer complaints have occurred when such steering wheels were used in particularly hot or cold temperature zones. Thus, the double-sided adhesive tape allows, at best, the leather cladding to be prepositioned during the manufacture of the leather steering wheel, but is entirely unsuitable for securing the leather cladding against slipping during the leather steering wheel's entire period of use.

As a further disadvantage of this known method it has emerged that the thickness of the leather cladding increases considerably due to the application of the double-sided adhesive tape, which, in some designs of leather steering wheels, has led to specific difficulties during processing.

Thus, the following description provides a method of manufacturing leather for the application of leather to components as well as such a component, with the above indicated disadvantages being avoided.

### SUMMARY

An exemplary embodiment provides an adhesive layer is applied to the rear side of the leather or, respectively, to a composite material face in case of a leather composite material, wherein a bonding adhesive is used for building up the adhesive layer, allowing repositioning of the leather or of the leather composite material essentially an arbitrary number of times. A person skilled in the art will understand the bonding adhesive to be an adhesive which remains highly viscous and permanently sticky upon application.

An advantage obtained as a result of the measures according to an exemplary embodiment is that the leather cladding can be positioned (stuck on and removed) on the steering wheel several times or essentially as often as wished before getting stuck in a groove and/or before being sewn up and thus the position of the leather cladding on the steering wheel can be optimized. Thereby, leather can be saved, since smaller excess lengths of the leather cladding as required for the application of leather will be necessary and hence the quality of the leather application can be increased as a whole.

A further advantage which has been obtained is that the application of leather to leather steering wheels can, for the first time, be repaired if, for example, a customer complaint occurs due to a defect of the leather. The seam can be opened and the leather cladding can be removed from the steering wheel in a nondestructive way without substantial expenditure of force even after months or years. The advantage thereof is that no residues of the removed leather cladding remain on the steering wheel and the steering wheel can immediately be covered with a different leather cladding of, for example, differently coloured leather. Since a great number of different types of steering wheels exist, it may happen that, from one model, not all can be sold. In such a case, the leather cladding can advantageously be removed from the steering wheel prior to the scrapping of the steering wheel and the leather cladding can optionally be supplied to another use.

A further advantage which has been obtained is that no formation of creases will occur in the leather surface because of the application of the bonding adhesive to the leather cladding or already to the leather skin, as a result of which substantially less waste is achieved during the application of leather to leather steering wheels. The method is also particularly inexpensive, since, as compared to the application of a double-sided adhesive tape, only one adhesive layer has to be applied in the method according to the invention. Also, the procedural step of cutting to size the double-sided adhesive tape can be omitted.

Particularly advantageous is also the fact that the leather cladding is virtually not stressed during the application of leather. It does not have to be heated for activating an adhesive, and it is not burdened by solvent vapours of a curing adhesive, either. As a result, a particularly beautiful and skin-friendly surface of the leather is obtained.

In particular manufacturing methods, the pure leather is not only cut to size first and sewn up into a leather cladding, but these processing steps are carried out directly with a composite material. Such a composite material has the leather on its uppermost layer, wherein, for example, a layer of foamed material can be provided underneath. The above indicated advantages are likewise obtained by providing the adhesive layer of bonding adhesive on the lowermost layer of the composite material.

In this method, it has furthermore turned out be advantageous to cut to size leather parts of the leather cladding prior to the application of the adhesive layer, this being feasible particularly advantageously by a punching process.

It has likewise turned out to be advantageous to perform the application of the adhesive layer after punching and before sewing up the leather parts into the leather cladding.

Since the bonding adhesive leaves no adhesive residues, the entire process of applying leather is substantially simplified. According to currently employed manufacturing methods, two-component adhesives are, for example, used for bonding, which adhesives often lead to adhesive residues on the leather surface, which then regularly results in customer complaints for the car manufacturer or end customer. By using a bonding adhesive, the number of customer complaints can be substantially reduced.

It has also turned out to be advantageous to apply a sealing layer such as, for example, a plastic film or a paper layer, to the adhesive layer after the application of the adhesive layer. In this way, the adhesive layer can be protected from impurities such as, e.g., dust and dirt prior to positioning. Depending on the manufacturing process, it may be advantageous to apply the adhesive layer already to the leather skin or to remove the sealing layer from the leather cladding only after the punching process and after sewing up the leather parts directly before the positioning on the steering wheel.

Furthermore, it has turned out to be advantageous to use bonding adhesives which are free from or at least low in organic solvents. In this way, the environment is protected, on the one hand, and, on the other hand, the surface of the leather steering wheel is not touched by solvents which might cause skin irritations in susceptible persons.

Further advantages are described below on the basis of an exemplary embodiment(s), with the invention not being limited to this exemplary embodiment, however.

### BRIEF DESCRIPTION OF THE DRAWINGS

FIG. 1 shows a top view of a leather steering wheel.

FIG. 2 shows a sectional view of the leather steering wheel according to FIG. 1.

FIG. 3 shows a sectional view of the cross-section of the grip part of the leather steering wheel.

### DETAILED DESCRIPTION

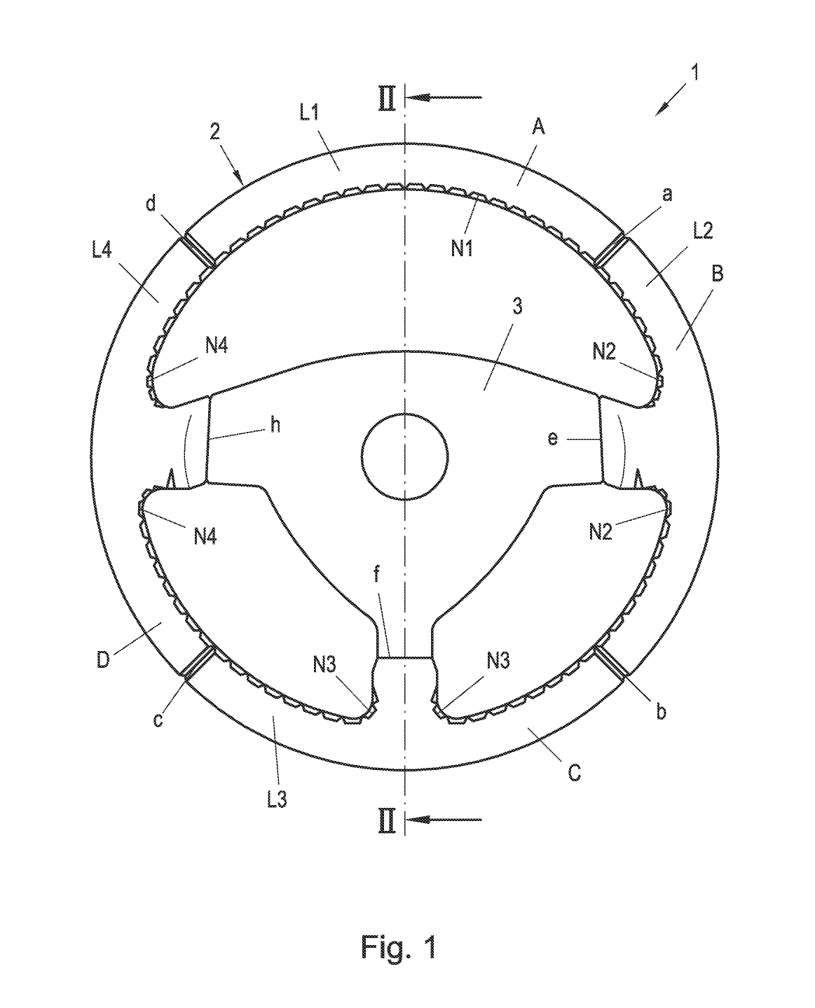

FIG. 1 shows a leather steering wheel 1 of a car. The leather steering wheel 1 comprises a grip part 2 and a spoke part 3. The grip part 2 is divided into four sections A, B, C and D which are offset against each other by, in each case, one groove a, b, c, and d running around the grip part. In order to envelop a steering wheel with leather during the manufacture of the steering wheel or to apply leather to the steering wheel, respectively, one so-called leather cladding is manufactured per each section of the steering wheel. The leather cladding consists of one or several sewn-together leather pieces which have been cut to size or, respectively, punched and sewn up such that the leather cladding fits precisely the respective section of the steering wheel. The leather cladding of the respective section is stuck plainly to the steering wheel and fixed to the steering wheel by means of the grooves and a seam.

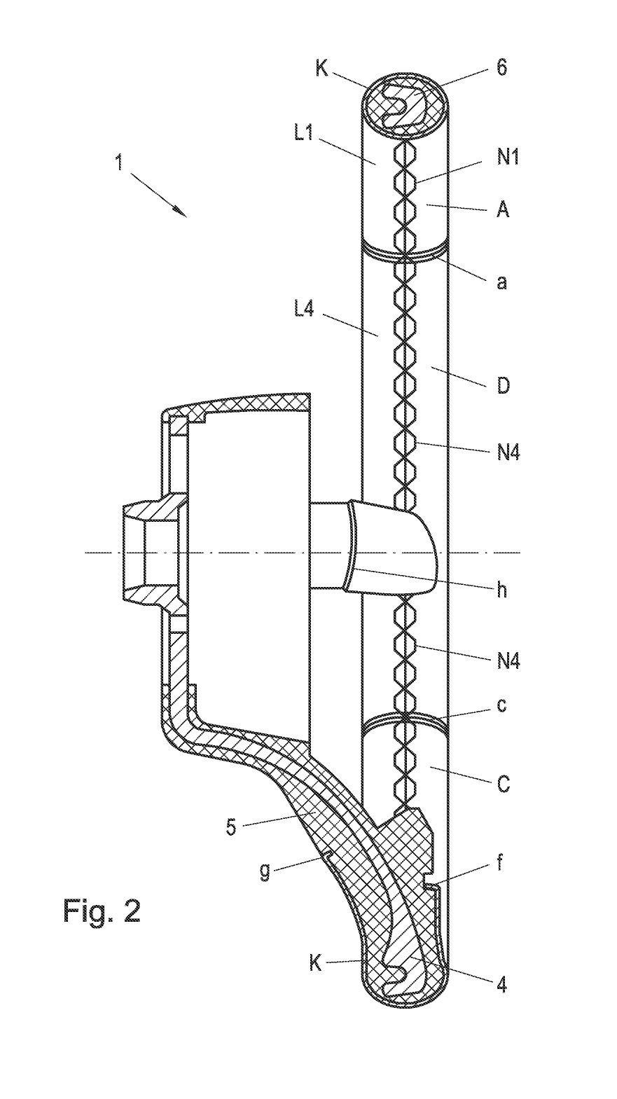

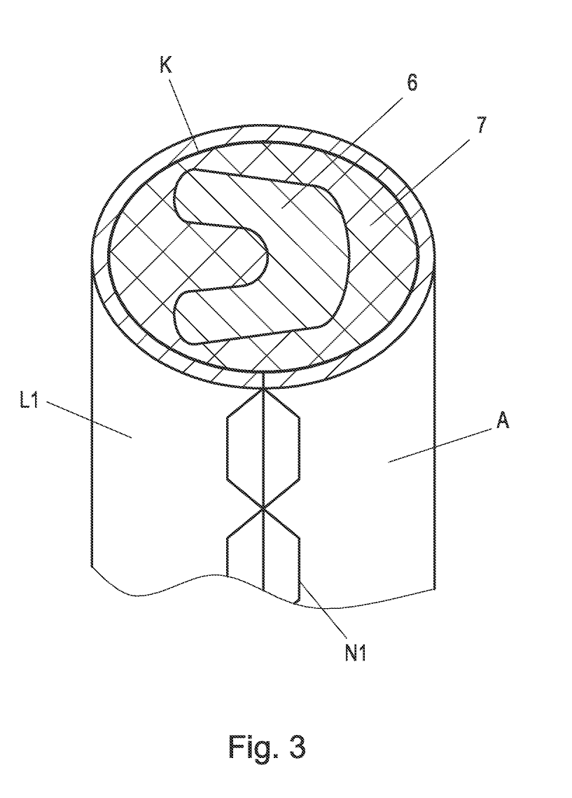

With the leather steering wheel 1 illustrated in FIGS. 1 to 3, a first leather cladding L1 covers the first section A of the hand part 2 of the leather steering wheel 1 and is fixed by the grooves a and d as well as a seam N1. A second leather cladding L2 covers the second section B of the hand part 2 and is fixed to the hand part 2 by the grooves a and b as well as to the spoke part 3 by a groove e and a groove which is not visible in the figures and a seam N2. A third leather cladding L3 covers the third section C of the hand part 2 and is fixed to the hand part 2 by the grooves b and c as well as to the spoke part 3 by grooves f and g and a seam N3. A fourth leather cladding L4 covers the fourth section D of the hand part 2 and is fixed to the hand part 2 by the grooves c and d as well as to the spoke part 3 by a groove h and a groove which is not visible in the figures and a seam N4.

The spoke part 3 of the leather steering wheel 1 comprises a metallic core 4 sheathed by a synthetic material 5. The hand part 2 of the leather steering wheel 1 also comprises a metallic core 6 sheathed by a flexible and relatively soft synthetic material 7 so that the leather cladding fixed thereon can be reversibly deformed slightly upon a comparatively strong pressure applied by the user.

In the method according to the invention for manufacturing the leather steering wheel 1, the component to be provided with leather, in this case the steering wheel which has no leather cladding yet, as well as the leather L intended for the leather application are now provided. On the basis of the design drawings of the steering wheel, the patterns for the individual leather claddings L1 to L4 of the leather steering wheel 1 are determined. Depending on the shape of the leather cladding to be produced, it may happen that a leather cladding has to be sewn together from two or several leather pieces, which is not the case with the leather cladding L1 to L4 illustrated in FIGS. 1 to 3.

The actual application of leather to the steering wheel 1 using the leather claddings L1 to L4 is a manual activity which is performed by a person and requires a lot of experience and skill. The application of leather to a steering wheel necessitates, on average, approximately one hour of manual activity. The person starts, for example, with the application of leather to section A of the leather steering wheel 1 by holding the leather cladding L1 over section A of the hand part 2 and checking whether the leather cladding L1 has appropriate dimensions so that the edges can be inserted into the grooves a and d and a uniform seam N1 can be effected. If the person finds that the first leather cladding L1 has the appropriate size, the first leather cladding L1 has to be prepositioned so that it will not slip when being sewn up and inserted into the grooves a and d.

The first leather cladding L1 now has an adhesive layer K of bonding adhesive on the underside of the leather, which bonding adhesive is characterized by its highly viscous and permanently sticky property. The adhesive layer H has already been applied during the manufacture of the leather or of the punched part, respectively, in one of the final processing steps and has been protected from contamination by a plastic film. Using a punching machine, the parts of the leather claddings L1 to L4 have been punched from the leather skin supporting the adhesive layer and the plastic film. Similarly, it would have been possible to apply the adhesive layer to the finished punched part and to protect it by a plastic film.

During the application of leather to the leather steering wheel 1, the person can now pull the plastic film from the adhesive layer K and preposition the leather cladding L1 on section A of the leather steering wheel 1. Usually, it is not possible to find the appropriate position of the leather cladding L1 during the first placing of the leather cladding L1 on section A. For example, the leather cladding L1 may be too long at groove a and, instead, too short at groove d or sufficient leather for accomplishing an optically flawless seam N1 may not be provided. Due to the properties of the bonding adhesive, the person is enabled to again pull the first leather cladding L1 from section A of the leather steering wheel 1 as often as necessary, that is, e.g., 10 or even 20 times, and to reposition it.

Since the bonding adhesive leaves no adhesive residues on section A of the leather steering wheel 1, the risk that the top side of the leather cladding L1 might be contaminated by adhesive residues does not exist. Due to the permanently viscous property of the bonding adhesive, the person is not hampered and distracted by processing periods or drying periods of the adhesive during the application of leather and may take the necessary time until the first leather cladding L1 has been prepositioned adequately. Subsequently, the person can press the leather cladding L1 into the grooves a and d and can start with sewing the seam N1. During sewing, the leather cladding L1 is safely kept from slipping by the adhesive layer K. As a result, the advantage is obtained that the first leather cladding L1 can be prepositioned for sewing particularly easily and without pressure of time and the risk of contaminating the leather top side and will keep its position also during sewing.

In the manner described, the remaining leather claddings L2 to L4 are subsequently prepositioned on sections B to D of the leather steering wheel 1 and fixed in the grooves a to h and then sewn up.

This also involves the advantage that the adhesive layer K is very thin and thus the thickness of the hand part 2 of the leather steering wheel 1 is not undesirably increased.

If the leather cladding of a leather steering wheel is made up of several pieces of leather, it may be advantageous to first punch out the leather parts, to sew them up and to apply the adhesive layer only to the sewn-up leather cladding. In this procedure, the demand for adhesive can be kept particularly low, since only parts which are actually intended for the application of leather to the steering wheel are coated with the adhesive.

If, during the manufacture of the leather, an adhesive layer has already been applied to the entire leather skin, it is advantageous to first sew together the parts of the leather cladding and to pull the sealing layer of the adhesive layer only from the finished leather cladding in order to avoid contaminations of the adhesive layer during sewing.

It may be mentioned that it is advantageous to provide only such parts of the leather skin with the adhesive layer which, according to the punching plan, are really intended for the application of leather to the leather steering wheel. In this way, adhesive can be saved and the punching residues of the leather skin may optionally be supplied to another use.

It may be mentioned that, for the application of leather to steering wheels, it is advantageous to use a bonding adhesive which maintains its specified adhesive properties in a temperature range of −60° C. to +150° C., in particular in a temperature range of −40° C. to +120° C. These temperature ranges are temperature ranges specified in the motor industry and the choice of such a bonding adhesive guarantees that the leather cladding is always secured against slipping.

It may be mentioned that a person skilled in the art will know bonding adhesives as such as Adhesin adhesives, for example, from the firm 3M as VHB adhesive films or from the firm Henkel.

It may be mentioned that not only the leather, but also a leather composite material layer is applied to some components. Such a composite material layer can be made up, for example, of a layer of leather and a layer of foamed material or a similar reversibly mouldable material applied to the leather underside. In such a case, the bonding adhesive is applied to the lowermost material layer (in this example a foamed material).

It may be mentioned that the method according to the invention for the manufacture of leather for the application of leather to components can also be used for applying leather to components which are completely different from steering wheels. For example, other vehicle space interior parts such as, e.g., the gearshift lever or the dashboard, or even boxes or chairs might also be furnished with leather.

1. A method of manufacturing leather for being applied to components, comprising:
providing manufactured leather, wherein,
an adhesive layer is applied to the a rear side of the leather or, respectively, to a composite material face in case of a leather composite material, wherein a bonding adhesive is used for building up the adhesive layer, allowing repositioning of the leather or of the leather composite material an arbitrary number of times.

2. The method according to claim 1, further comprising, before the application of the adhesive layer, the leather is cut to size appropriately into leather parts during a punching process for the application of leather.

3. The method according to claim 2, further comprising, before or after the application of the adhesive layer, leather parts are sewed together into a leather cladding for the application of leather in a sewing operation.

4. The method according to claim 1, wherein a sealing layer is applied to the bonding adhesive after the application of the adhesive layer.

5. The method according to claim 4, wherein the sealing layer is removed for the application of leather to the component only after the sewing operation.

6. The method according to claim 1, wherein the adhesive layer is applied only to those surface sections on the leather which, according to a punching plan, are intended for being punched out and for the application of leather to a leather steering wheel.

7. A component comprising a leather surface produced by the application of leather, wherein an adhesive layer of bonding adhesive is provided on the a rear side of the leather or, respectively, on the a composite material face in case of a leather composite material, allowing repositioning of the leather or of the leather composite material essentially an arbitrary number of times.

8. A The component according to claim 7, wherein the bonding adhesive is low in or, respectively, free from organic solvents.

9. A The component according to claim 7, wherein the component is constituted by a leather steering wheel.

10. A The component according to claim 7, wherein the bonding adhesive maintains its specified adhesive properties in a temperature range of −60° C. to +150° C., in particular in a temperature range of −40° C. to +120° C.

11. The method according to claim 2, wherein a sealing layer is applied to the bonding adhesive after the application of the adhesive layer.

12. The method according to claim 3, wherein a sealing layer is applied to the bonding adhesive after the application of the adhesive layer.

13. The method according to claim 4, wherein the adhesive layer is applied only to those surface sections on the leather which, according to a punching plan, are intended for being punched out and for the application of leather to a leather steering wheel.

14. The method according to claim 5, wherein the adhesive layer is applied only to those surface sections on the leather which, according to a punching plan, are intended for being punched out and for the application of leather to a leather steering wheel.

15. The component according to claim 8, wherein the component is constituted by a leather steering wheel.

16. The component according to claim 9, whererin the bonding adhesive maintains its specified adhesive properties in a temperature range of −60° C. to +150° C., in particular in a temperature range of −40° C. to +120° C.
